(19) United States
(12) Patent Application Publication
(10) Pub. No.: US 2014/0367325 A1
(43) Pub. Date: Dec. 18, 2014

(54) Method for Multi-Stage Expansion and Stretching of Film and Filter

(71) Applicants: Kyung-Ju Choi, Louisville, KY (US); Yoshiyuki Shibuya, Osaka (JP); Kunihiko Inui, Osaka (JP)

(72) Inventors: Kyung-Ju Choi, Louisville, KY (US); Yoshiyuki Shibuya, Osaka (JP); Kunihiko Inui, Osaka (JP)

(21) Appl. No.: 12/483,341

(22) Filed: Jun. 12, 2009

Related U.S. Application Data
(60) Provisional application No. 61/061,345, filed on Jun. 13, 2008.

(51) Int. Cl. B01D 29/07; B29C 55/02

(52) U.S. Cl. 210/493.5; 264/291

(57) ABSTRACT

This invention relates to a multi-stage stretching operation for production of expanded stretched porous polytetrafluoroethylene (ePTFE) fibrous materials with minimal node size and minimized filament sizes. A plurality of stretching or expansions may be implemented on the film including combinations of MDO and TDO stretches including at least two longitudinal stretches and at least one transverse stretch. Subsequent stretches occur at rates generally less than a prior similar longitudinal or transverse type of expansion.

This application claims benefit to and priority under 35 USC § 119 from pending provisional application Ser. No. 61/061,345 filed Jun. 13, 2008, the entire content of which is incorporated herein.

### FIELD OF THE INVENTION

This invention relates to a multi-stage stretching operation for production of expanded stretched porous polytetrafluoroethylene (ePTFE) fibrous materials with minimal node size and minimized filament sizes. These materials may be utilized in applications such as filters for use in filters for gas turbine air intakes, air conditioners, ventilation, vacuum cleaners, air cleaners, air conditioning systems, semiconductor plant clean rooms, dust collection, pharmaceutical manufacturing facilities and the like.

### BRIEF DESCRIPTION OF THE DRAWING

FIG. 1 is a schematic view of the machine direction orientation (MDO) process described herein in exemplary form;

FIG. 2 is a schematic of the transverse direction orientation (TDO) process described herein in exemplary form.

### DETAILED DESCRIPTION OF THE INVENTION

It is to be understood that the invention is not limited in its application to the method and the arrangement of the various steps set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” “in communication with” and “mounted” and variations thereof herein are used broadly and encompass direct and indirect connections, couplings, and mountings. In addition, the terms “connected” and “coupled” and variations thereof are not restricted to physical or mechanical connections or couplings.

Furthermore, and as described in subsequent paragraphs, the specific configurations described are intended to exemplify embodiments of the invention and that other alternative configurations are possible.

In traditional process for producing ePTFE structures, calendared PTFE tapes are created which present characteristics of low resistance to fluid flow and airflow. However, these calendared PTFE tapes typically contain less uniform microstructures of nodes and fibrils which may be modified through the utilization of expansion steps by increasing stress induced crystallization which often yield a more opened and much finer and stronger filaments of ePTFE structure and, if preferentially performed in the proper steps, a more efficient and uniform microstructure of the fibrils and nodes, with nodes being diminished as significantly as possible. As can be understood, the expansion ratio may be increased substantially but with such increase in expansion ratio, a higher flow and porosity material may be created which coincidentally increases the yield of a higher flow nano-filtration material but reduces the material per square area of material stretched thereby increasing strength and applicability for filtering technologies as preferred herein. It is desirable to provide a methodology for stretching and creating PTFE polymers which have membrane characteristics of efficient airflow qualities, improved strength of the fibrils and uniform presentation in the microstructure space and finer filament size.

Various methodologies have been suggested for stretching PTFE materials such as U.S. Pat. No. 3,953,566, incorporated by reference, which creates a node and fibril microstructure characterized by a series of nodes which are interconnected by mesh fibrils. Such material is amorphously locked by heating above the melting point of PTFE, typically above 330 degrees Celsius. After amorphous locking of the material, additional stretching occurs at temperature above the crystalline melt point to create a material with a large plurality of nodes which are oriented perpendicular to the direction of the expansion. Porosity of the film created in such a methodology is increased due to creation of voids or spaces between polymeric nodes and fibrils become much more numerous and significantly larger in size after the amorphous locking and stretching steps. The methodology set forth however required amorphous locking and high temperature treatment of the polymer between and during stretching steps, raising the temperature of the material above the crystalline melt point in order to properly lock the polymeric chains at each method step.

Alternatively, U.S. Pat. No. 5,476,589, incorporated herein by reference, discloses a thin porous polytetrafluoroethylene membrane with relatively high airflow through rate. However, in the teachings thereof, a substantially thickened extrudite of above 500 micrometer is initially stretched transversely with a subsequent high ratio longitudinal stretch. However, the initial thick material extrudite and preliminary transverse stretch increases the nodal characteristics of the material thereby presenting stretched film characteristics undesirable for high efficiency rating and usage.

U.S. Pat. No. 5,814,405 incorporated herein by reference, similarly discloses a ePTFE structure resulting in a series of rib like rows and nodes wherein the material is amorphously locked and stretched after beginning with a highly dense and thickened extruded paste. The stretching of the amorphously locked film occurs at temperatures above the crystalline melt point resulting in inefficiencies of the processing of the material.

In utilizing the various methodologies for creation of ePTFE, increase in the ratio of expansion of the PTFE typically increases the pore size of resulting porous expanded article. The larger pore size with nano-sized filaments results directly in the lower flow resistance through ePTFE but effects also the filtration efficiencies especially for smaller particles as to maintain such efficiencies. Additional stretching tends to decrease ePTFE thickness which further results in reduction of flow resistance and decrease in filtration efficiency. Thus, while it is known in various teachings described herein to improve the efficiencies of ePTFE through multiple stretching, a clear need still exists for thin strong ePTFE's exhibiting high efficiency, minimal node size, strengthened fibril formation which creates both nano-sized filaments and low flow resistance to create an ePTFE which may directly be applicable for utilization and filtering technologies and the like. Such creation of stretched films with high efficiencies and low flow resistance desirably exhibit such strength in fibril characteristics with an increased permeability and ability to transmit fluids through the pores of the filtering material when subjected to different pressures across the filter media. Such high permeability or high flow through characteristics described herein for ePTFE for a given pressure drop across the filter media afford low energy costs due to low energy loss and more rapid filtration times of the material flowing through the filter media.

In air filtration, it is generally known that the finer the filament size, the better the efficiency. Therefore, the goal of utilizing a proper ePTFE material is to extend the filaments to make possible fully extended PTFE chain molecules right prior to C—C covalent bond breakage to establish molecular level sized filaments by multi-stage stretching and chain molecules relaxation with stress induced crystallization techniques. The nodes of PTFE used in the sheet material hereof contain folded stacks of lamellar structure. The multi-stage stretching methodology described herein achieves various desirable characteristics of the ePTFE material by using the highest possible stretch rate at the appropriate annealing temperature to maximize the stress induced crystallization discussed herein. As an example for utilization of the stretching methodology set forth herein with the various embodiments disclosed, pre-forming of the paste like extruded polymeric material may be accomplished by beginning with a fine PTFE powder as is known and adding a lubricant or other material therein. The lubricant may be Isopar or other lubricant such as water and the like to form a paste which may then be extruded under high pressure. Lubricants may be incorporated at an exemplary rate of 10 to 60 and more preferably from about 20 to 30 percent dependent upon the particular type of lubricant implemented. Under high pressure, the material may be paste extruded at 230 PSI or more and at room temperature or higher to create an extrudite or otherwise form a tape of 10 to 300 microns in thickness. There is no particular limit or specification on the type or amount of lubricant required as long as the lubricant is capable of moistening the powder and may be subsequently removed by evaporation or heating. In placing the paste material under high pressure, it is desirable that the liquid lubricant is not released from the material by such pressure such that a tape is provided with proper characteristics for calendaring through a calendar roll to create the tape from high pressure extrusion, the calendaring occurring at high temperature, preferably anywhere from 80 up to 400 degrees Celsius. Typically, heat and pressure are applied to the paste while passing it between heated rollers.

Subsequent to calendaring at the dictated temperature, the tape may then be stretched according to the various embodiments of the multistage stretching set forth herein in order to obtain a porous ePTFE sheet. Advantageously, the PTFE film at initial processing stage of stretching is about 8 to 10 inches in width and between about 10 to 300 micrometers in thickness. The band material may be collected within a roll or may be fed directly from the calendaring processing stages to a machine direction orienting (MDO) expander. As is known, the MDO expander utilizes two primary drums, the first drum having a slower circumferential rotational speed than the secondary drum. The film is fed over the circumferential surface of the first drum and to the circumferential surface of the second drum thereby performing an expansion of ePTFE film in a longitudinal direction to form initial stages of the ePTFE film described herein. The MDO stretching on the MDO expander may be performed at between 150 degrees Celsius to 400 degrees Celsius and preferably at approximately 250 degrees Celsius. It is preferable to perform such initial MDO stretching to maximize the strength of the fibrils formed from the nodes. As is known, the nodes are then formed and stretched perpendicular to the MDO direction while the strengthening fibrils are formed and stretched the MDO direction. Initial stretching in the machine direction expander may be done at ranges from about 1.5 to about 80 to 1 (1.5:1 to 80:1) and advantageously may be in the range from about 5 to 1 to about 20 to 1 (5:1 to 20:1). After the initial MDO expansion, the ePTFE is allowed to relax to rest the polymer chain molecules and prevent breakage of covalent C—C bonds which can subsequently lead to tearing or shredding especially between longitudinally extending polymer chain molecules at near expansion temperature. The relaxation time may be from between 2 seconds to approximately about 10 minutes in order to provide the preferred orientation of the polymer chain orientation. Once the polymer chains properly orient themselves after the relaxation step, subsequent stretching at higher temperatures may occur, preferably at higher temperatures than the initial MDO stretching in order to provide and create stronger fibrils located between nodes. Defects of ePTFE are reduced by making the second MD ratio less than the first MD ratio.

As is known, node formation in the stretched film occurs during the various stretching steps, the node formation occurring in a direction perpendicular to the direction of stretching. These node formations create ovalized nodes within the material separated by fibrils extending between the nodes, the fibrils being stretched in a direction parallel to the direction of stretching. Preferably, in the methodology set forth herein, node size is minimized significantly through subsequent stretching thereby increasing the strength and number of fibrils, correctly orienting the fibrils and minimizing significantly the node size in the sheet material formed.

Subsequent expansion stages of the ePTFE occur in a longitudinal direction with an additional MDO orientation step or with a transverse direction orientation (TDO) stretch in TDO machine. The ePTFE is then expanded in a third stage in an MDO or TDO machine. The process comprises at least three stages and has at least one TDO expansion stage. The ePTFE sheet is allowed to relax between each stretching stage as set forth and the expanding ratio of the ePTFE and subsequent expansion stages is preferably equal to or less than the ratio of previous expansions relative to the machine direction orientation or transverse direction orientation stretch.

TDO stretching may be implemented through a tenter stretcher wherein the sheet is placed and held by tenter clips which stretch the web of material transversely in a tenter frame. Such tenter machines typically utilize tenter clips held on an endless traveling carrier in order to provide width wise tension on the material. Tenter machines may be utilized to provide the transverse direction orientation of the material and stretching thereof. These tenter machines are utilized for heat setting of plastic materials and fixation of chemical finishes and the likes on other materials. Typical tenter frames utilize ovens to provide heat sufficient enough to properly condition the polymeric materials. Radiant heat and/or heated air blowers may be utilized to distribute air through the tenter frame while the sheet is transported along a longitudinal tentering path typically at ranges of about 200 degrees Celsius to about 300 up to about 450 degrees Celsius. As is known, the tentering frame utilizes a mechanism for driving an endless carrier chain of tentering clips or other mechanisms for maintaining tension on the edges of the ePTFE sheet. The endless support chains for the tentering clips form a close loop path guided by tentering rails adjacent to the edges of the sheet material. As the material progresses along the tentering machine, the tentering rails diverge providing the desired expansion and stretching of the ePTFE material under the high heat conditions defined herein.

For example, a process is disclosed for preparing a thin and porous ePTFE sheet of material which may be utilized as a filtration media. The process includes preparing an initial layer of PTFE film through paste extrusion and the like, the extruded PTFE film being provided at approximately 8 to 10 inches in width and from approximately 10 to about 300 microns in thickness. This high pressure extrusion process for forming the sheet of PTFE begins with the utilization of a PTFE resin powder or the like which may be combined with various lubricants known in the industry and which allow the PTFE film or sheet to be extruded under high pressures as appropriately required. Upon appropriate extrusion, the PTFE film is then expanded under multiple steps, the multiple steps including at least two machine direction orientation stretching steps and at least one transverse direction orientation stretch. The initial stretching and expansion step should be a machine direction orientation expansion. Each expansion occurs from about 150 degrees Celsius to about 450 degrees Celsius and preferably at about 250 degrees Celsius for initial stretching. Subsequent to the initial stretch, subsequent stretches may occur at higher temperatures in order to generally maximize the strength of the fibers created between nodes within the stretched film. Between stretches, relaxation occurs for allowance of the molecules to orient properly, the relaxation allowing higher temperatures to be utilized in subsequent stretching while also increasing the strength of the fibrils noted. The first expansion may occur at a ratio of about 1½ to 1 to about approximately 80 to 1. Subsequent expansions of the ePTFE film may occur at preferably equal or reduced stretching ratios for similar type expansions. Multiple MDO expansions or TDO expansions may be implemented utilizing the method hereof each subsequent expansion of similar type orientation occurring at a similar or reduced expansion ratio and possibly at higher or increased expansion temperatures. Relaxation is allowed between each of the expansion stages as noted from about 2 to 3 seconds up to about 20 to 30 minutes. The ePTFE layer may be about 10 nanometers to about 30 micrometers.

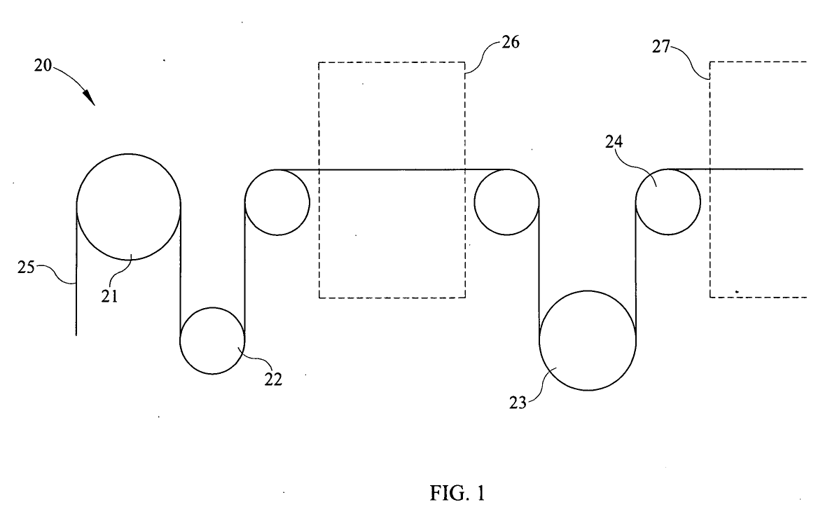

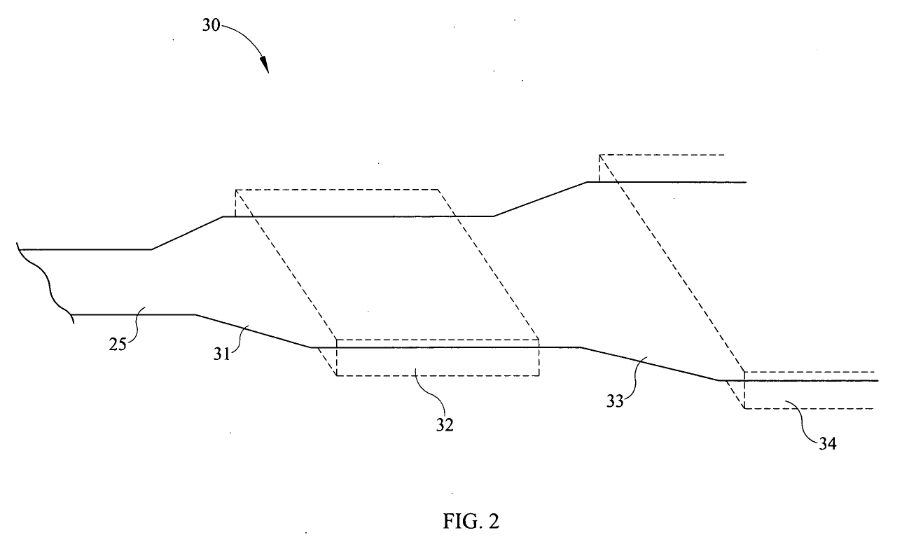

FIGS. 1 and 2 depict both machine direction orientation stretching and transverse direction orientation stretching through various mechanisms. As shown in FIG. 1, the PTFE tape 25 is fed to a pair of rollers, a slow roller 21 and fast roller 22, a plurality of pairs may form the MDO stretching system 20. Subsequent pairs of slow and fast rollers may be separated with a relaxation chamber 26, 27 as shown. Thus, in the MDO stretching machinery 20 depicted in exemplary fashion, slow rollers 21, 23 are paired with fast rollers 22, 24 in order to stretch the tape 25 in the machine direction. Adequate relaxation time is provided in each of the relaxation chambers 26, 27 and pairs of slow and fast rollers shown may be interspersed or separated by various other stretching mechanisms, such as a TDO stretching machine 30.

As depicted in FIG. 2, the transverse direction orientation may be implemented through various known machinery wherein the tape 25 is taken through a tenter frame and stretched in the TDO or transverse direction at 31 followed by a relaxation chamber 32 with subsequent tenter frame stretching 33 shown paired with additional relaxation chamber 34. Again, as shown with the MDO stretching station 20, the various stretching stations shown herein and depicted in exemplary fashion may be interspersed with both TDO and MDO or MDO and TDO combinations as set forth herein in the various embodiments described as the figures are given for exemplary purposes only.

The machinery depicted herein are exemplary only and as is well known, variations on the direction of stretching, combination of slow fast roller pairs and tenter frame stretching may be implemented through the techniques outlined herein and incorporated within the claims appended hereto.

The following examples are given for explanation purposes only and are not considered to be limiting in nature. The various embodiments and examples depicted herein exhibit portions of the presently defined methodology for creation of the ePTFE utilizing the steps outlined hereof and set forth in the following claims.

### EXAMPLE 1

A PTFE film extruded to approximately 8 to 10 inches in width and approximately 200 micrometers thick was placed into an MDO expander and stretched longitudinally at a ratio of 7 to 1 within the MDO expander. This MDO expansion step was followed by a relaxation period of approximately 5 seconds to 10 minutes after which a subsequent MDO longitudinal expansion occurred at a ratio of approximately 5 to 1. Both longitudinal stretches occurred at approximately 250 degrees Celsius wherein the drums of the MDO expander were heated to the desired temperature. After the secondary MDO expansion step, a transverse stretch of the material and a tenter frame was accomplished utilizing a transverse expansion ratio of 35 to 1. As can be seen, the expansion ratio of the subsequent MDO expansion stages was less than the primary MDO expansion stage. The resulting ePTFE film formed from the stretching stages noted herein exhibited a lower pressure drop and higher airflow through rates for gas and air filters. Amorphous locking occurred after the final step wherein the ePTFE film formed by the prior expansion stages was raised to approximately 340 degrees Celsius in order to reach an onset of melting point for the polymer film.

### EXAMPLE 2

The same PTFE file noted above was expanded in an MDO expansion direction at a ratio of approximately 6 to 1 with a relaxation stage followed therein. A subsequent MDO expansion at approximately 4 to 1 ratio was accomplished with an additional MDO expansion of approximately 2 to 1 ratio. All MDO expansions were followed by relaxation steps of approximately 5 seconds to 10 minutes. Finally, after the third MDO expansion step, a final transverse expansion and a tenter frame for a TDO expansion rate of 35 to 1 was accomplished. Again, amorphous locking of the finally stretched ePTFE material was done at a high enough temperature, approximately 340 degrees Celsius, to lock the polymer chains in position and orientation thereby making the fibrils formed strong and node formation minimal in the finally formed ePTFE film.

### EXAMPLE 3

The PTFE film or sheet noted above was initially expanded in an MDO expansion stage at approximately 250 degrees Celsius at a ratio of about 8 to 1. This longitudinal expansion was followed by a transverse expansion at a TDO expansion rate of approximately 10 to 1. After stretching, proper relaxation was allowed in between the MDO and TDO expansion stages. Following the transverse expansion stage within the tenter frame, an additional machine direction orientation was accomplished at approximately 5 to 1 ratio at the above noted temperature or higher. Finally, as a final stage, an additional transverse direction orientation in a tenter frame was accomplished at a ratio of approximately 5 to 1. Note that the subsequent stretching of similar type expansions, either MDO or TDO, occurred at a reduced expansion rate as the prior expansion stage. Proper relaxation was allowed between each of the expansion stages as noted. Finally, amorphous locking of the polymer chains was accomplished by raising the final sheet temperature to approximately 340 degrees Celsius in order to maintain proper stretched orientation of the polymer chains and the fibrils formed.

### EXAMPLE 4

The PTFE film or sheet material noted above was initially expanded in a machine direction orientation machine approximately 6 to 1 at a temperature of approximately 250 degrees Celsius. Relaxation was allowed of the expanded sheet and a subsequent machine direction orientation expansion was accomplished at a ratio of approximately 6 to 1. Relaxation again was allowed to occur to allow the polymer chains to orient appropriately. A third expansion stage of a transverse direction orientation in a tenter frame occurred at a ratio of approximately 10 to 1 with relaxation and an additional transverse direction orientation stretch occurred at a ratio of approximately 5 to 1. Again, adequate relaxation was allowed between expansion stages. Finally, amorphous locking of the stretch material was allowed at a higher temperature, such higher temperature allowing amorphous locking of the polymer chains while maintaining the temperature below the crystallization point of the film.

### EXAMPLE 5

The PTFE film or sheet noted above was initially stretched in an MDO roll machine at approximately 6 to 1 ratio followed by subsequent MDO stretches at subsequent ratios of 4 to 1 and 2 to 1. Appropriate relaxation stages were allowed between the stretching actions. Subsequent to the last stretching stage, two transverse direction orientation stretches occurred, the first occurring at approximately a 10 to 1 ratio and the second at approximately 5 to 1 ratio with appropriate relaxation allowed between the stages. Amorphous locking was followed the final TDO stage and a sheet with strengthened fibrils and minimal node formation was achieved.

### EXAMPLE 6

A PTFE film or sheet material noted above was initially stretched in an MDO roller machine at the noted temperature at about 6 to 1 ratio with a relaxation step and subsequent MDO stretch at approximately 4 to 1 ratio. A TDO stretch occurred in a tenter frame at approximately 10 to 1 ratio with a subsequent MDO stretching in the MDO roller at a ratio of approximately 2 to 1. Finally, a TDO stretching occurred in the tenter frame at a ratio of approximately 5 to 1. Amorphous locking occurred after the final stretch and adequate relaxation was allowed prior to each of the stretching or subsequent to each of the stretching steps.

### EXAMPLE 7

The following expansion stages in the PTFE film or sheet noted above was accomplished:
MDO at approximately 6 to 1 followed by a TDO at approximately 10 to 1, MDO at approximately 4 to 1 followed by a TDO at approximately 3 to 1 and finally an MDO at approximately 2 to 1 followed by a TDO at approximately 2 to 1. This six stage stretch of the ePTFE was accomplished with minimal tears and formations of rips or defects within the final sheet amorphous locking strengthened the final material appropriately for utilization in adequate filtering technologies.

### EXAMPLE 8

An ePTFE film was made accordingly to the following method. The ePTFE film was stretch through three successive MDO stretches at successively reduced ratios of 6, 4 and 2 to 1. The MDO stretches were conducted at the following corresponding increasing temperatures, 200, 250 and 300 degrees Celsius. Relaxation of the film after MDO stretching was allowed after each stretch of about two hours. After the final TDO stretch at a ratio of about 35 to 1, a short relaxation was allowed for approximately two minutes. This film was then laminated with a dri-laid scrim material, the material then pleated at six pleats per inch to form a two inch mini-pleat. The dimension of the filter was twenty four by twenty four by two (24×24×2) inches. The filter provided an estimated gross media area of 88 square feet. Testing was conducted on the filter at a barometric pressure of 29.62 in. Hg., temperature of 71 degrees F. and a relative humidity of 44%. Testing was conducted at an airflow rate of 1968 CFM with a nominal face velocity of 492 fpm. The initial resistance was 0.67 WG with an E1% initial efficiency 0.30-1.0 um of 97%, E2% initial efficiency 1.0-3.0 um at 98% and E3% initial efficiency 3.0-10.0 um of 99%. The pressure drop exhibited for an initial efficiency of MERV 16 was noticed at 0.67 WG. This should be compared to corresponding glass fiber MERV 15 (lower minimum efficiency) 24×24×4 inch pleat exhibiting a pressure drop of 0.75 WG or a MERV 14 24×24×4 glass fiber filter exhibiting a rated initial resistance in WG of 0.65. Such comparison indicates that compared to the prior art fiberglass filter having half the surface area, i.e. two (2) inch depth, will have a comparable efficiency pressure drop of 1.50 WG with a lower efficiency. The filter of the present invention therefore exhibits less than half the pressure drop of the current fiberglass product at a higher efficiency.

The present invention provides for a method of making a porous expanded PTFE (ePTFE) by forming a tape of PTFE polymer in a range of about 10 to about 300 microns in thickness, passing the tape of PTFE through a machine direction orienting machine at a first ratio of from about 1.5:1 up to about 80:1, relaxing the ePTFE polymer chain molecules to prevent breakage of covalent C—C bonds, expanding the ePTFE film in a machine direction orienting machine to a second ratio preferably equal to or less than the first ratio, relaxing the ePTFE polymer chain molecules, expanding the ePTFE film in a transverse direction orienting machine to a third ratio from about 1.5:1 up to about 100:1, locking amorphously the ePTFE sheet into a sheet of ePTFE of about 10 nanometers to about 30 microns thick.

The present invention further describes an ePTFE layered pleated filter having an upstream and downstream side, the pleated filter having a support scrim with a non-woven material and a layer of expanded polytetrafluoroethylene (ePTFE), the ePTFE being expanded by a multi-stretching method, wherein the filter is used as filtration media having Gurley stiffness of at least 300 mg, an efficiency in a range of 40% to 99.999995% at a most penetrating particle size and a permeability in a range of 1 to 400 cfm/sq ft; the media having a pleatable support scrim; the pleatable support scrim being provided by carding, wet laying, meltblowing or spunbonding the polymeric fibers forming a non-woven scrim. The filter provided has an initial resistance of about 0.67 WG, an E1% initial efficiency 0.30-1.0 um of about 97%, an E2 percentage initial efficiency 1.0-3.0 um of about 98% and an E3 initial efficiency of 3.0-10.0 um of about 99%. The filter further has an ePTFE film after the expansion of about 10 nanometers to 30 microns thick.

It is to be noted that in the examples listed herein, each of the stages of stretching was separated by a relaxation step noted above. The relaxation step may be accomplished through resting of the polymeric chains formed for the material within the film and may occur at approximately two seconds to up to about ten minutes at various known temperatures. Generally, depending on molecular orientation, varying relaxation temperatures may be utilized. For very high molecular orientation, temperatures more than 360 C. degrees may be implemented. At intermediate molecular orientations, about 340 degrees C. may be implemented. And for low molecular orientations, about 270 degrees C. may be used. These relaxation steps strengthen the film material after each of the stepping stages thereby increasing the final film strength and fibril formation. It indicated in the ePTFE sheets formed with the process parameters noted herein exhibited significantly reduced node formation while strengthened and properly oriented fibril formation was achieved.

The foregoing description of structures and methods has been presented for purposes of illustration. It is not intended to be exhaustive or to limit the invention to the precise steps and/or forms disclosed, and obviously many modifications and variations are possible in light of the above teaching. It is understood that while certain forms of expansion of PTFE films have been illustrated and described, it is not limited thereto except insofar as such limitations are included in the following claims and allowable functional equivalents thereof.

1. A method of making a porous expanded PTFE (ePTFE) comprising:
a. preparing a tape of PTFE polymer in a range of about 10 to about 300 microns in thickness;
b. expanding said tape of PTFE in a machine direction orienting machine at a first ratio of from about 4:1 up to about 80:1;
c. relaxing said ePTFE polymer chain molecules to prevent breakage of covalent C—C bonds;
d. expanding said ePTFE film in a machine direction orienting machine to a second ratio less than said first ratio;
e. relaxing said ePTFE polymer chain molecules;
f. expanding said ePTFE film in a transverse direction orienting machine to a third ratio from about 1.5:1 up to about 100:1;
g. locking amorphously said ePTFE into a sheet of ePTFE of about 10 nanometers to about 30 microns thick.

2. (canceled)

3. The method of claim 1 further comprising expanding said ePTFE film in a transverse direction orienting machine prior to said amorphous locking to a fourth ratio equal to or less than said third ratio and after allowing said ePTFE to relax prior to said transverse orienting.

4. (canceled)

5. The method of claim 1 further comprising combining said ePTFE with at least a first support scrim with a non-woven material wherein a portion of fibers are made of blends of polymeric materials; and bonding a layer of said ePTFE having a first surface to said first support scrim.

6. The method of claim 5, wherein said filtration media after said combining step exhibits a Gurley stiffness of at least 300 mg.

7. The method of claim 5, said filtration media having an efficiency in a range of 40% to 99.999995% at a most penetrating particle size and having a permeability in a range of 1 to 400 cfm/sq ft.

8. A process for expanding a thin porous ePTFE for use as filtration media, comprising:
a. preparing a PTFE tape having a thickness in a range of 10 to 300 microns;
b. longitudinally expanding said layer a first ratio of from about 4:1 up to about 80:1;
c. allowing said expanded layer to relax to prevent breakage of covalent C—C bonds;
d. expanding said ePTFE layer a second and a third time, said second and third expansion being either a longitudinal expansion less than said first ratio or a transverse expansion a third expansion ratio, said third expansion ratio of from about 1.5:1 to about 100:1;
e. relaxing said ePTFE polymer chain molecules between said second and third expansions;
f. amorphously locking said ePTFE.

9. The process of claim 8 further comprising a fourth additional longitudinal expansion to a ratio equal to or less than said second ratio;

10. The process of claim 8 further comprising a fourth additional transverse expansion to a ratio equal to or less than said third ratio.

11. The process of claim 8 further comprising combining said ePTFE with a first support scrim with a non-woven material wherein said fibers are made of blends of polymeric materials; and bonding a layer of said ePTFE having a first surface to said first support scrim.

12. The process of claim 8 wherein said filtration media has a permeability in a range of 1 to 400 cfm/sq ft.

13. A process for preparing a thin porous ePTFE as a filtration media, comprising:
a. preparing an initial layer of PTFE film at a thickness in a range of 10 to 300 micrometers;
b. longitudinally expanding said film in first expansion a first ratio of about 4:1 up to about 80:1;
c. allowing said ePTFE film to relax to prevent breakage of covalent C—C bonds;
d. following said first expansion of said film with a plurality of subsequent expansion, each of said subsequent expansions being either a subsequent longitudinal expansion or a transverse expansion, each of said subsequent expansions followed by a relaxing step to prevent breakage of covalent C—C bonds;
e. wherein said plurality of subsequent expansions includes at least one transverse expansion;
f. wherein each of said plurality of subsequent expansions are completed at an expansion ratio less than the prior similar type of longitudinal or transverse expansion;
g. amorphously locking said ePTFE film after the last of said expansions to about 10 nanometers to 30 microns.

14. The process of claim 13 further comprising: combining said ePTFE with a first support scrim; pleating said combined filtration media.

15. The process of claim 14 wherein said combining step of said multi-layer first support scrim has a first layer bonded to said first surface of said ePTFE, includes combining said ePTFE with a support scrim having at least 30% blended polymers.

16. A method of making a filtration media with ePTFE, comprising:
a. supplying a quantity of polymeric fibers,
b. carding, wet laying, meltblowing or spunbonding said polymeric fibers forming a non-woven support scrim,
c. feeding said support scrim to a heat roll;
d. preparing an initial layer of PTFE film at a thickness in a range of 10 to 300 micrometers;
e. longitudinally expanding said film in first expansion a first ratio of about 4:1 up to about 80:1;
f. following said first expansion of said film with a plurality of subsequent expansion, each of said subsequent expansions being either a subsequent longitudinal expansion or a transverse expansion;
g. wherein said plurality of subsequent expansions includes at least one transverse expansion;
h. wherein each of said plurality of subsequent expansions are completed at an expansion ratio less than the prior similar type of longitudinal or transverse expansion;
i. amorphously locking said ePTFE film after the last of said expansions;
j. feeding ePTFE to said heat roll;
k. contacting said support scrim to said ePTFE;
l. bonding said ePTFE to said support scrim forming a layered filter media; and
m. pleating said layered media.

17. (canceled)

18. (canceled)

19. (canceled)

20. (canceled)

21. The method of claim 1 wherein the expanding said tape of PTFE in the machine direction at the first ratio is completed at a first temperature and the expanding said ePTFE film in the machine direction to the second ratio less than said first ratio is completed subsequently at a second temperature higher than the first temperature.

22. The method of claim 8 wherein the longitudinally expanding said layer at the first ratio is completed at a first temperature and one of said subsequent expansions being said longitudinal expansion at less than said first ratio is completed subsequently at a second temperature higher than the first temperature.

23. The method of claim 13 wherein the longitudinally expanding said film in first expansion at said first ratio is completed at a first temperature and said subsequent said expansions at the expansion ratio less than said longitudinally expanding is completed subsequently at second temperature higher than the first temperature.

24. The method of claim 16 wherein the longitudinally expanding said film in said first expansion at said first ratio is completed at a first temperature and said subsequent expansions at said expansion ratio less than said longitudinally expanding is completed subsequently at second temperature higher than the first temperature.
